(19) United States
(12) Patent Application Publication
(10) Pub. No.: US 2006/0040048 A1
(43) Pub. Date: Feb. 23, 2006

(54) Continuous in-line manufacturing process for high speed coating deposition via a kinetic spray process

(76) Inventors: Taeyoung Han, Bloomfield Hills, MI (US); Zhibo Zhao, Ann Arbor, MI (US); Bryan A. Gillispie, Warren, MI (US); John R. Smith, Birmingham, MI (US); John S. Rosen JR., Williamsville, NY (US)

Correspondence Address: SCOTT A. MCBAIN;DELPHI TECHNOLOGIES, INC., Legal Staff, Mail Code: 480-410-202, P.O. Box 5052, Troy, MI, 48007-5052, US

(21) Appl. No.: 10/924,270

(22) Filed: Aug. 23, 2004

(51) Int. Cl. B05D 1/08; B05D 1/12; B05C 5/00

(52) U.S. Cl. 427/180; 427/421.1; 118/300; 427/446

(57) ABSTRACT

An improved kinetic spray system and a method for using the same in a high speed manufacturing environment are disclosed. The improved kinetic spray nozzle system comprises: a gas/powder exchange chamber connected to a first end of a powder/gas conditioning chamber having a length along a longitudinal axis of equal to or greater than 20 millimeters; a converging diverging supersonic nozzle, the supersonic nozzle having a converging section separated from a diverging section by a throat, the diverging section comprising a first portion and a second portion, with the first portion having a cross-sectional area that increases along a length of the first portion and with the second portion having a substantially constant cross-sectional area along a length of the second portion; and the converging section connected to a second end of the powder/gas conditioning chamber opposite the first end. The method includes: use of the disclosed nozzle system with the addition of hard particles that permit maximum enhancement of particle temperature while not permitting clogging of the nozzle; use of controlled particle feed rates to match the desired very high traverse speeds; and use of pre-heating of the substrate to clean it an to enhance particle bonding. With the disclosed nozzle system coupled with the disclosed methods one can apply kinetic spray coatings at traverse speeds of over 200 centimeters per second with a deposition efficiency of over 80 percent.

### TECHNICAL FIELD

The present invention relates to coating a substrate by a kinetic spray process, and more particularly, to an improved nozzle system to permit high speed continuous in-line coating deposition using a kinetic spray system.

### INCORPORATION BY REFERENCE

U.S. Pat. No. 6,139,913, “Kinetic Spray Coating Method and Apparatus”, and U.S. Pat. No. 6,283,386 “Kinetic Spray Coating Apparatus” are incorporated by reference herein.

### BACKGROUND OF THE INVENTION

The prior art for kinetic spray systems generally discloses a kinetic spray system having a nozzle system that includes a gas/powder exchange chamber directly connected to a converging diverging deLaval type supersonic nozzle. The system introduces a stream of powder particles under positive pressure into the exchange chamber. Typically, the powder gas, which is used to drive the powder to the exchanger chamber, is not heated to prevent powder from clogging the powder pipeline. A heated main gas is also introduced into the exchange chamber under a pressure, which is set lower than the pressure of the powder particle stream. In the exchange chamber the heated main gas and the particles mix and because of the very short residence time, the power particles are heated only slightly and significantly below their melting point even when the main gas is at a temperature that is several fold above the melting temperature for certain low melting temperature materials. The heated main gas and the particles flow from the exchange chamber into the supersonic nozzle where the particles are accelerated to a velocity of from 200 to 1,300 meters per second. The particles exit the nozzle and adhere to a substrate placed opposite the nozzle provided that a critical velocity has been exceeded.

The critical velocity of a particle is dependent upon its material composition and its size. Harder particles generally need a higher velocity to result in adherence and it is more difficult to accelerate large particles to high velocities. The prior art system has been shown to work with many different types of particles, however, some particle sizes and material compositions have not been successfully sprayed to date. Prior to the present invention numerous attempts have been made to coat substrates with harder particles or larger particles. These attempts have been largely unsuccessful. In addition, the coating density and deposition efficiency of the particles can be very low with harder to spray particles. The particle velocity upon exit from the nozzle varies approximately inversely to the particle size and the particle density. Increasing the velocity of the main gas by increasing its temperature should increase the particle velocity upon exit. There is a limit, however, to the main gas velocities and temperatures that can be achieved within the system. If the main gas temperature is too high the powder particles begin to adhere to the inside of the nozzle, which causes poor deposition and requires a nozzle cleaning.

A recent improvement in the ability to spray difficult to deposit particles is disclosed in co-pending U.S. application Ser. No. 10/808,245, filed on Mar. 24, 2004. The co-pending application discloses an improved nozzle design that incorporates a powder/gas conditioning chamber into the nozzle. This leads to a dramatic ability to spray previously difficult to spray powders at higher deposition efficiency. Although the co-pending system improved the deposition efficiency for difficult to spray powders by increasing the particle temperatures it, however, has limitations for some very hard powders, powders that are hard with low melting temperatures, or with very large particles. Certain particle populations such as brazing alloys formed from, for example, aluminum, silicon, and zinc, still are difficult to deposit because they become gummy in the nozzle and stick to its interior when the particle temperatures are too high, which reduces deposition efficiency. As a result, the traverse speeds of substrates need to be reduced greatly to obtain a coating with adequate thickness and mass loading. For example, one has to use a traverse speed of from 1.25 to 2.5 centimeters/second to deposit a ternary braze alloy of AL-Sn-Zi that is equivalent to a monolayer of prayed particles. Such traverse speeds are far too slow to make them useful when a manufacturing environment requires high deposition efficiency with high traverse speeds in the range of 25 to 250 centimeters per second. Thus, there is a critical need to develop a suitable kinetic spray system that will allow for high deposition efficiency of a wide range of materials at high traverse speeds of 25 centimeters per second and higher while keeping the nozzle clean.

### SUMMARY OF THE INVENTION

In one embodiment, the present invention is a method of kinetic spray coating a substrate comprising the steps of: providing particles of a powder; injecting the particles into a gas/powder exchange chamber and entraining the particles into a flow of a main gas in the gas/powder exchange chamber, the main gas at a temperature insufficient to heat the particles to a temperature above a melting temperature of the particles; directing the particles entrained in the main gas in the gas/powder exchange chamber into a powder/gas conditioning chamber having a length along a longitudinal axis of equal to or greater than 20 millimeters; directing the particles entrained in the flow of gas from the conditioning chamber into a converging diverging supersonic nozzle, said nozzle having a diverging section comprising a first portion and a second portion, said first portion having a cross-sectional area that increases along a length of said first portion and said second portion having a substantially constant cross-sectional area along a length of said second portion; and accelerating the particles to a velocity sufficient to result in adherence of the particles on a substrate positioned opposite the nozzle.

In another embodiment, the present invention is a kinetic spray nozzle system comprising: a gas/powder exchange chamber connected to a first end of a powder/gas conditioning chamber having a length along a longitudinal axis of equal to or greater than 20 millimeters; a converging diverging supersonic nozzle, the supersonic nozzle having converging section separated from a diverging section by a throat, the diverging section comprising a first portion and a second portion, the first portion having a cross-sectional area that increases along a length of the first portion and the second portion having a substantially constant cross-sectional area along a length of the second portion; and the converging section connected to a second end of the powder/gas conditioning chamber opposite the first end.

### BRIEF DESCRIPTION OF THE DRAWINGS

FIG. 1 is a schematic layout illustrating a kinetic spray system for using the nozzle of the present invention;

FIG. 2 is an enlarged cross-sectional view of a nozzle system designed in accordance with the present invention for use in a kinetic spray system;

FIG. 3 is a photomicrograph of a substrate sprayed via a kinetic spray nozzle designed in accordance with the prior art;

FIGS. 4A and 4B are scanning electron micrographs of the coatings shown in FIG. 3 strips a and g, respectively;

FIGS. 5A and 5B are photomicrographs of an exit end of the prior art kinetic spray nozzle before FIG. 3 strip a was sprayed and after FIG. 3 strip h was sprayed, respectively;

FIG. 6A is a graph demonstrating the effect of the level of silicon carbide addition on the ability to coat a substrate according to the present invention;

FIG. 6B is a graph demonstrating the effect of the level of silicon carbide addition on the coating deposition efficiency on a substrate according to the present invention;

FIG. 7 is a schematic diagram showing one use of the present invention as an in-line addition to a condenser tube extrusion process;

FIG. 8 is a schematic diagram showing one use of the present invention as an in-line addition to a condenser tube spool to spool process;

FIG. 9 is a scanning photomicrograph of a cross-section of a condenser tube to condenser core braze joint prepared according to the present invention; and

FIG. 10 is a graph showing the effect of preheating the substrate on the amount of coating that adheres to the substrate sprayed according to the present invention.

### DESCRIPTION OF THE PREFERRED EMBODIMENT

The present invention comprises a dramatic improvement to the kinetic spray process and nozzle system as generally described in U.S. Pat. Nos. 6,139,913 and 6,283,386.

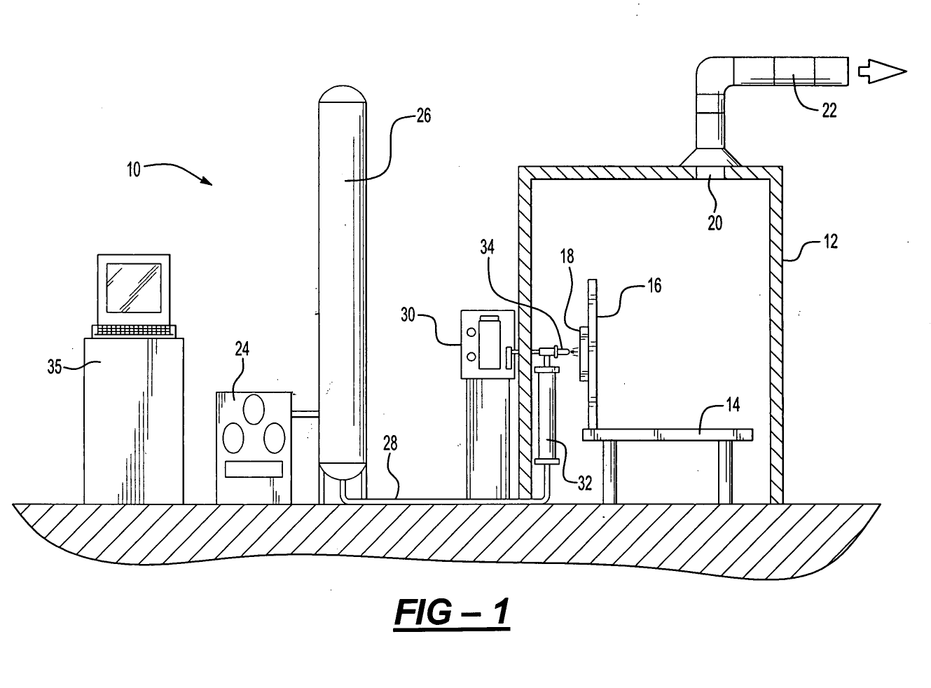

Referring first to FIG. 1, a kinetic spray system for use of a nozzle designed according to the present invention is generally shown at 10. System 10 can include an enclosure 12 in which a support table 14 or other support means is located. A mounting panel 16 fixed to the table 14 supports a work holder 18. Work holder 18 can have a variety of configurations depending on the type of substrate to be coated. For example, work holder 18 can be configured for the present invention as a plurality of high speed rollers capable of moving a substrate past a nozzle 34 at traverse speeds in excess of 250 centimeters per second. In other embodiments, work holder 18 can be capable of movement in three dimensions and able to support a suitable workpiece formed of a substrate material to be coated. The enclosure 12 can include surrounding walls having at least one air inlet, not shown, and an air outlet 20 connected by a suitable exhaust conduit 22 to a dust collector, not shown. During coating operations, the dust collector continually draws air from the enclosure 12 and collects any dust or particles contained in the exhaust air for subsequent disposal or recycling.

The spray system 10 includes a gas compressor 24 capable of supplying gas at a pressure up to 3.4 MPa (500 psi) to a high pressure gas ballast tank 26. Many gases can be used in the present invention including air, helium, argon, nitrogen, and other noble gases. The gas ballast tank 26 is connected through a line 28 to both a high pressure powder feeder 30 and a separate gas heater 32. The gas heater 32 supplies high pressure heated gas, the heated main gas, described below, to a kinetic spray nozzle 34. The powder feeder 30 mixes particles of a powder to be sprayed with heated or unheated high pressure gas and supplies the mixture to a supplemental inlet line 48 of the nozzle 34. In some embodiments the powder gas is heated and in others the powder gas is not heated to prevent powder lines from clogging. A computer control 35 operates to control the pressure of gas supplied to the gas heater 32, the pressure of gas supplied to the powder feeder 30, the temperature of the gas supplied to the powder feeder 30, and the temperature of the heated main gas exiting the gas heater 32.

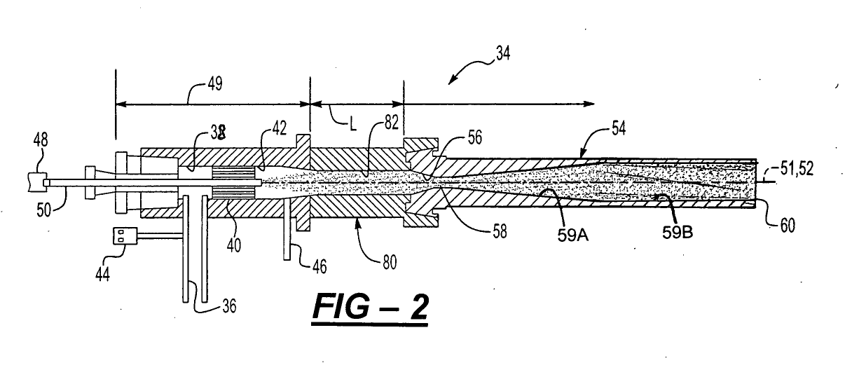

FIG. 2 is a cross-sectional view of a nozzle 34 designed in accordance with the present invention for use in the system 10 and its connections to the gas heater 32 and the supplemental inlet line 48. A main gas passage 36 connects the gas heater 32 to the nozzle 34. Passage 36 connects with a premix chamber 38 which directs gas through a flow straightener 40 and into a mixing chamber 42. Temperature and pressure of the heated main gas are monitored by a gas inlet temperature thermocouple 44 in the passage 36 and a pressure sensor 46 connected to the mixing chamber 42. The premix chamber 38, flow straightener 40, and mixing chamber 42 form a gas/powder exchange chamber 49.

A mixture of high pressure gas and coating powder is fed through the supplemental inlet line 48 to a powder injector tube 50 having a central axis 52 which is preferably the same as a central axis 51 of the gas/powder exchange chamber 49. The length of chamber 49 is preferably from 40 to 80 millimeters. Preferably, the injector tube 50 has an inner diameter of from about 0.3 to 3.0 millimeters. The tube 50 extends through the premix chamber 38 and the flow straightener 40 into the mixing chamber 42.

Mixing chamber 42 is in communication with a powder/gas conditioning chamber 80 positioned between the gas/powder exchange chamber 49 and a supersonic nozzle 54. The powder/gas conditioning chamber 80 has a length L along its longitudinal axis. The axis 52 is the same as axis 51 in this embodiment. Preferably the interior of the powder/gas conditioning chamber 80 has a cylindrical shape 82. Also preferably its interior diameter matches the entrance of a converging section of the supersonic nozzle 54. The powder/gas conditioning chamber 80 releasably engages both the supersonic nozzle 54 and the gas/powder exchange chamber 49. Preferably, the releasable engagement is via correspondingly engaging threads on the gas/powder exchange chamber 49, the nozzle 54, and the powder/gas conditioning chamber 80 (not shown). The releaseable engagement could be via other means such as snap fits, bayonet-type connections and others known to those of skill in the art. The length L along the longitudinal axis is preferably at least 20 millimeters or longer. The optimal length of the powder/gas conditioning chamber 80 depends on the particles that are being sprayed and the substrate that is being sprayed with the particles. Preferably the length L ranges from 20 to 450 millimeters. With the insertion of the powder/gas conditioning chamber 80, the distance between the exit of the injector tube 50 and the adjacent end of the nozzle 54 is significantly increased compared to the prior art. The increased distance permitted by the conditioning chamber 80 allows for a longer residence time of the particles in the main gas prior to entry into the supersonic nozzle 54. This longer residence time leads to a higher particle temperature, more homogeneous main gas powder intermixing, and a more homogeneous flow of the gas powder mixture. Thus, it is predicted that particles will achieve a higher temperature, closer to but still well below their melting point, prior to entry into the supersonic nozzle 54.

Supersonic nozzle 54 is a de Laval type converging diverging nozzle 54. The nozzle 54 has an entrance cone 56 that decreases in diameter to a throat 58. The entrance cone 56 forms a converging section of the nozzle 54. Downstream of the throat 58 is an exit end 60. The largest diameter of the entrance cone 56 may range from 10 to 6 millimeters, with 7.5 millimeters being preferred. The entrance cone 56 narrows to the throat 58. The throat 58 may have a diameter of from 1.0 to 6.0 millimeters, with from 2 to 5 millimeters being preferred. The nozzle 54 also includes a diverging section that extends from a downstream side of the throat 58 to the exit end 60. In the present invention the diverging section has been modified from the prior art. The diverging section includes a first portion 59A adjacent the throat 58 and a second portion 59B adjacent the first portion 59A. In the first portion 59A the cross-sectional area of the nozzle 54 rapidly expands. In the second portion 59B the cross-sectional area of the nozzle 54 remains substantially constant and does not expand. The prior art only has the first portion 59A of the nozzle 54. Preferably the overall length of the diverging section is from 350 to 1000 millimeters and more preferably from 400 to 800 millimeters. Preferably the first portion 59A is from 200 to 400 millimeters in length and preferably the second portion 59B is from 150 to 800 millimeters in length. The diverging section may have a variety of shapes, but in a preferred embodiment it has a rectangular cross-sectional shape. At the exit end 60 the nozzle 54 preferably has a rectangular shape with a long dimension of from 6 to 24 millimeters by a short dimension of from 1 to 6 millimeters.

As disclosed in U.S. Pat. Nos. 6,139,913 and 6,283,386 the powder injector tube 50 supplies a particle powder mixture to the system 10 under a pressure in excess of the pressure of the heated main gas from the passage 36. Preferably the gas supplied to the powder feeder 30 is at a pressure sufficiently high enough that the powder particles leave the injector tube 50 at a pressure that is 15 to 150 pounds per square inch above the main gas pressure, more preferably at a pressure that is 15 to 75 pounds per square inch above the main gas pressure. In some embodiments the gas supplied to the powder feeder is heated to a temperature of from 40 to 200° C.

The nozzle 54 produces an exit velocity of the entrained particles of from 200 meters per second to as high as 1300 meters per second. The entrained particles gain primarily kinetic energy during their flow through the nozzle 54. It will be recognized by those of skill in the art that the temperature of the particles in the gas stream will vary depending on the particle size and the main gas temperature. The main gas temperature is defined as the temperature of heated high-pressure gas at the inlet to the nozzle 54. The main gas temperature can be substantially above the melting temperature of the particles being sprayed. In fact, the main gas temperature can vary from about 200 to 2000 degrees Celsius or as high as several fold above the melting point of the particles being sprayed depending on the particle material. Despite these high main gas temperatures the particle temperature is at all times lower than the melting point of the particles. This is because the powders are injected into the heated gas stream by the powder gas and the exposure time of the particles to the heated main gas is relatively short. Therefore, even upon impact there is no change in the solid phase of the original particles due to transfer of kinetic and thermal energy, and no change in their original physical properties. The particles are always at a temperature below their melting point. The particles exiting the nozzle 54 are directed toward a surface of a substrate to coat it.

Upon striking a substrate opposite the nozzle 54 the particles flatten into a nub-like structure with a varying aspect ratio generally depending on the types of sprayed materials. When the substrate is a metal and the particles are a metal the particles striking the substrate surface fracture the surface oxide layer and subsequently form a direct metal-to-metal bond between the metal particle and the metal substrate. Upon impact the kinetic sprayed particles transfer all of their kinetic and thermal energy to the substrate surface and stick onto the substrate. As discussed above, for a given particle to adhere to a substrate it is necessary that it reach or exceed its critical velocity which is defined as the velocity at which it will adhere to a substrate when it strikes the substrate after exiting the nozzle 54. This critical velocity is dependent on the material composition of the particle and the material composition of the substrate. In general, harder materials must achieve a higher critical velocity before they adhere to a given substrate and harder substrates must be struck at a higher velocity. It is not known at this time exactly what is the nature of the particle to substrate bond; however, it is believed that for the metal particles incident on a metal substrate, a portion of the bond is metallic or metal to metal due to the particles plastically deforming upon striking the substrate and thereby fracturing oxide layers exposing the underlying metal.

As disclosed in U.S. Pat. No. 6,139,913 the substrate material may be comprised of any of a wide variety of materials including a metal, an alloy, a plastic, a polymer, a ceramic, a wood, a semiconductor, and mixtures of these materials. All of these substrates can be coated by the process of the present invention. Preferably the stand off distance from the substrate is from 5 to 60 millimeters, and more preferably from 10 to 50 millimeters. The particles used in the present invention may comprise any of the materials disclosed in U.S. Pat. Nos. 6,139,913 and 6,283,386 in addition to other know particles. These particles generally comprise a metal, an alloy, a ceramic, a polymer, a diamond, a metal coated ceramic, a semiconductor, or mixtures of these. Preferably, the particles have an average nominal diameter of from about 1 to 250 microns. One preferred use of the present invention is to deposit brazing alloys onto surfaces. Preferably the brazing alloys are mixtures of aluminum, silicon, and zinc. In one embodiment it is preferred that the alloy comprise from 50 to 78% by weight aluminum, 5 to 10% by weight silicon, and 12 to 45% by weight zinc based on the total weight.

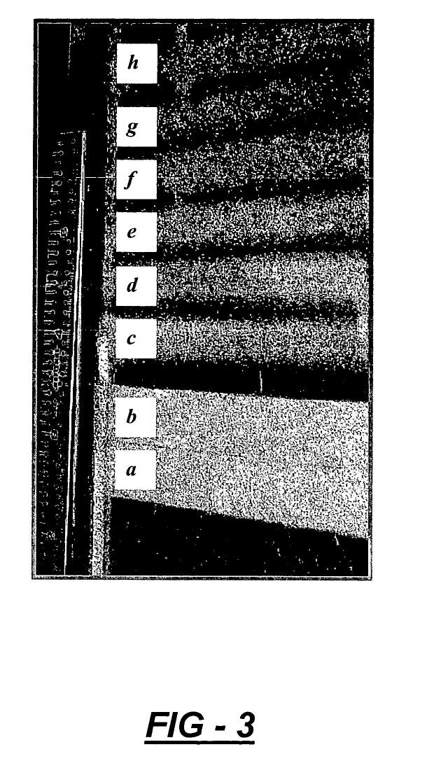

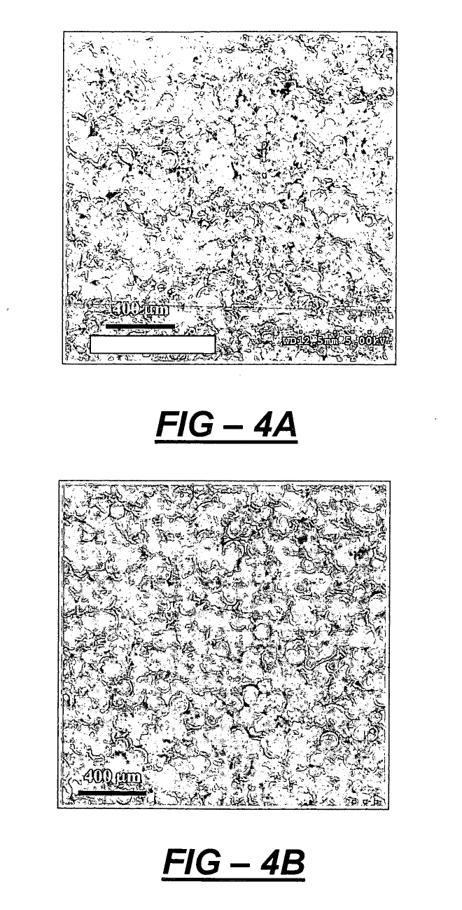

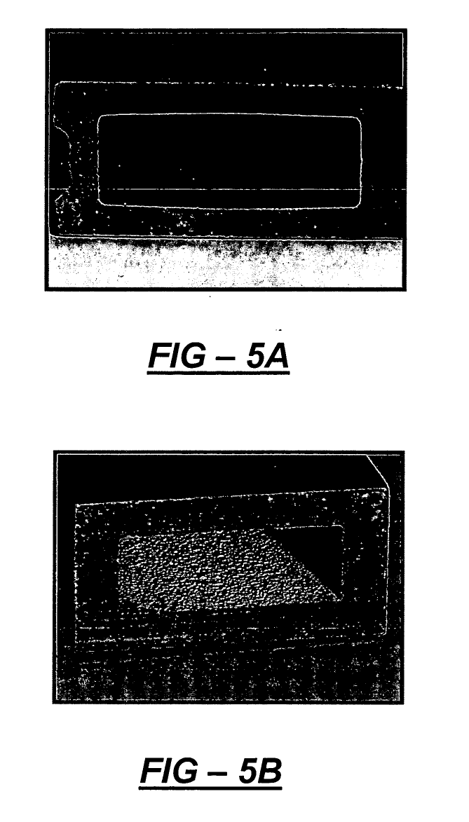

FIG. 3 is a photomicrograph of a substrate kinetically sprayed using a prior art kinetic spray process. Lanes a and b were sprayed right after the nozzle had been cleaned, as shown in FIG. 5A. Lanes c-h were sprayed right after lanes a and b. The nozzle interior after lane h is show in FIG. 5B. Notice the heavy particle build up in the nozzle and the poor deposition quality. The spray parameters were as follows: main gas pressure 300 psi, powder gas pressure 350 psi, main gas temperature 650° C., powder feed rate of 0.5 grams/second, stand off distance of 20 millimeters and a traverse speed of 1.25 centimeters per second. The powder particles were a brazing alloy mixture of aluminum, silicon, and zinc. In FIGS. 4A and 4B scanning photomicrographs of the coating surfaces in lanes a and g are shown. Note the low density of the particles that stick to the substrate in 4B versus 4A. In FIG. 4A, the particles become highly deformed and closely packed, a clear indicator of high particle velocities and high deposition efficiency. In the case of FIG. 4B, the majority of the particles that strike the substrate fall off after collision, which is evidenced by the high density of crater marks. The deposit of alloy on the nozzle walls, as shown in FIG. 5B, is believed to cause the boundary layer to thicken and to reduce the particle velocities.

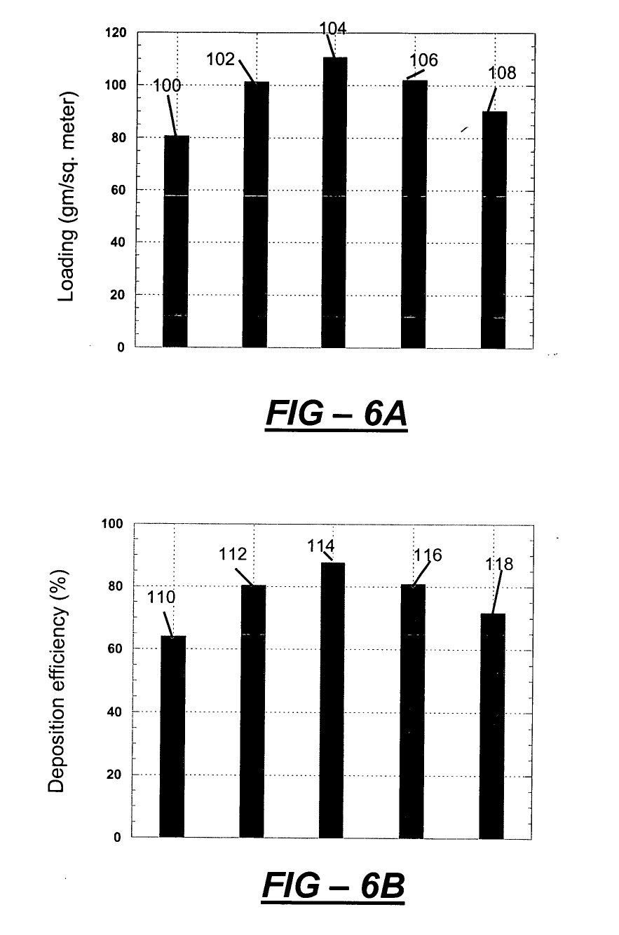

In an attempt to improve the ability to spray these brazing alloys the present inventors incorporated an additional hard component into the alloy, namely a ceramic. A diamond or other hard material is also believed to be suitable. The ceramic chosen was silicon carbide; however, other ceramics will also work. The importance is that the second population of particles be too hard to adhere to the substrate under the spraying conditions, it instead serves to scour the inside of the nozzle and keep it clean. It is preferable that the hard particle, such as silicon carbide, be included at levels of from 1 to 20% by weight based on the total weight. The same particle sizes can be used. In FIGS. 6A and 6B the dramatic improvement using a nozzle designed according to the present invention and silicon carbide is shown. Using a prior art nozzle the main gas temperature was limited to 650° C., a traverse rate of 1.25 centimeters per second and a deposition efficiency of from 3 to 5%. In the results shown in FIGS. 6A and 6B the spray parameters were as follows: main gas pressure 300 psi, powder gas pressure 320 psi, main gas temperature 1000° C., powder feed rate 1.00 grams per second, stand off distance of 20 millimeters, and traverse rate of 60 centimeters per second. In reference lines 100, 102, 110, and 112 the silicon carbide particles have an average nominal diameter of from 25 to 45 microns. In the other reference lines the average nominal diameter is from 63 to 90 microns. Reference lines 100 and 110 show the effect of 4% by weight of silicon carbide. In reference lines 102 and 112 the effect of 7% by weight of silicon carbide is shown. In reference lines 104 and 114 the effect of 4% by weigh of silicon carbide is shown. In reference lines 106 and 116 the effect of 7% by weight silicon carbide are shown. In reference lines 108 and 118 the effect of 10% by weight silicon is shown. Generally it is preferred that the loading on a condenser tube be from 40 to 80 grams per square meter. The results show that small amounts of the harder silicon carbide provide dramatic improvements in the ability to deposit a gummy material like an alloy of aluminum, silicon, and zinc. The traverse speed was set 24-fold higher, the main gas temperature could be increased by 400° C., the deposition efficiencies were at least 12 fold higher, and the loading was well above that need to effectively coat condenser tubes.

Using the sort of data shown in FIGS. 6A and 6B one is able to calculate the required powder feed rates that are necessary to sustain a loading of at least 80 grams per square meter onto a condenser tube 18 millimeters wide at any of several assumed deposition efficiencies and traverse speeds. The results of such calculations are shown in Table 1 below.

TABLE 1

| Traverse speed | Feed rate at | Feed rate at | Feed rate at |
|---|---|---|---|
| (centimeters/ | 100% DE | 80% DE | 50% DE |
| second) | (grams/second) | (grams/second) | (grams/second) |
| 30 | 0.45 | 0.56 | 0.90 |
| 60 | 0.90 | 1.13 | 1.80 |
| 90 | 1.35 | 1.70 | 2.70 |
| 120 | 1.80 | 2.25 | 3.60 |
| 180 | 2.70 | 3.38 | 5.40 |
| 200 | 3.00 | 3.80 | 6.00 |

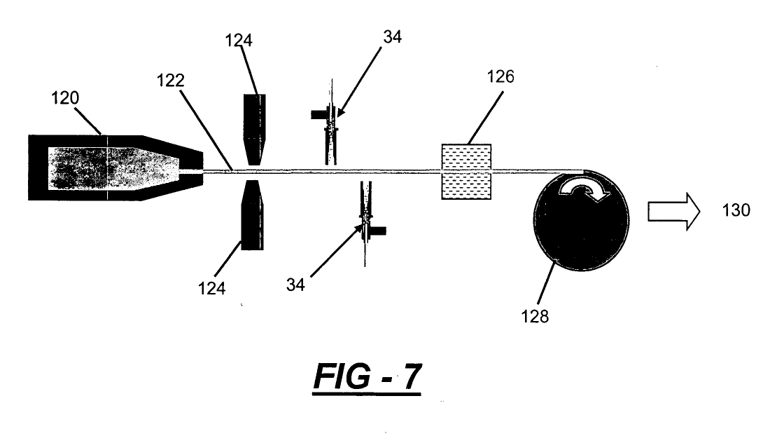

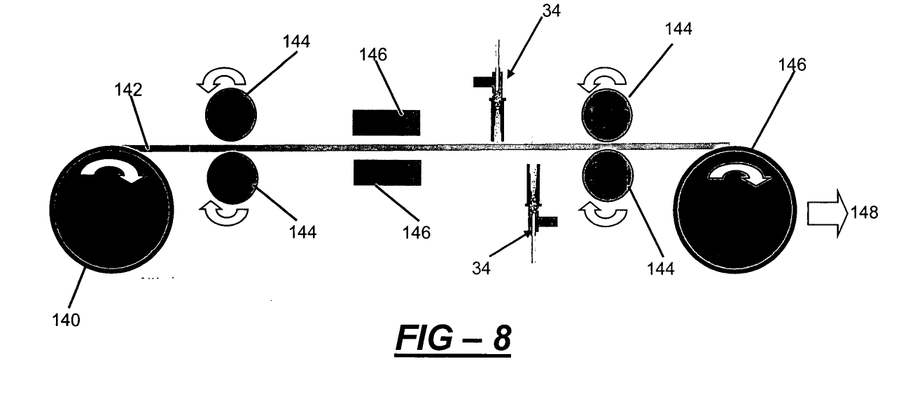

Given the dramatic improvement in the ability to deposit coatings efficiently at very high traverse speeds provided by the present invention one can see its use in high speed manufacturing environments. Examples of such are shown in FIGS. 7 and 8. FIG. 7 is a schematic diagram showing an in-line inclusion of the present invention in an extrusion line for condenser tubes. The substrate could be any high speed extrudate material. In FIG. 7 an extruder 120 continuously extrudes a condenser tube 122 at a temperature of approximately 550° C. The extruded tube 122 passes past a pair of air coolers 124 and then past a pair of kinetic spray nozzles 34 designed according to the present invention where the tube 122 is coated by the nozzles 34. The coated tube 122 passes through a cooling water bath 126 and then is taken up on a wrap spool 128. The wrapped tube can subsequently be straightened and cut to size 130. In another embodiment the nozzles 34 of the present invention are used in a spool to spool operation as shown in FIG. 8. A spool 140 contains wrapped extruded tube 142 which is removed from the spool 140 by drive rollers 144. The drive rollers 144 feed the tube 142 past heaters 146 and then past a pair of nozzles 34 designed according to the present invention. The nozzles 34 coat the tube 142 which is subsequently coiled onto another spool 146. Later the coated tube 142 can be straightened and cut to length 148. The proposed continuous in-line manufacturing process combined with the advanced kinetic spray process is the key enabler to minimize the cycle time and manufacturing cost while improving the coating quality and deposition efficiency. This continuous in-line process also can eliminate the need for pre-heating the substrate. The pre-heating of the substrate can improve deposition efficiency. In the example shown in FIG. 7, the substrate temperature is fairly high, near 550° C., right after the extrusion and in this in-line process no pre-heating is required before the substrate is passed in front of the nozzles 54.

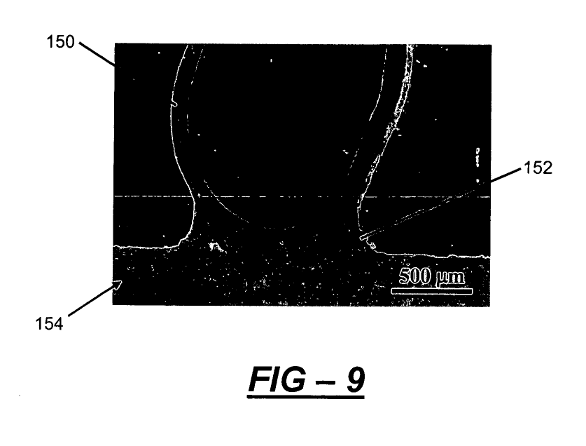

In FIG. 9 a photomicrograph of a cross-section of a radiator core 154 brazed according to the present invention is shown. The brazing alloy applied according to the present invention was an alloy of aluminum, silicon, and zinc premixed with the hard silicon carbide. The spray parameters were as follows: main gas pressure 300 psi, powder gas pressure 330 psi, main gas temperature 1100° C., powder feed rate 4.00 grams per second, stand off distance of 22 millimeters, powder/gas conditioning chamber length 131 millimeters, and traverse speed of 200 centimeters per second. The condenser tube 150 shows an excellent braze joint 152 to the core 154.

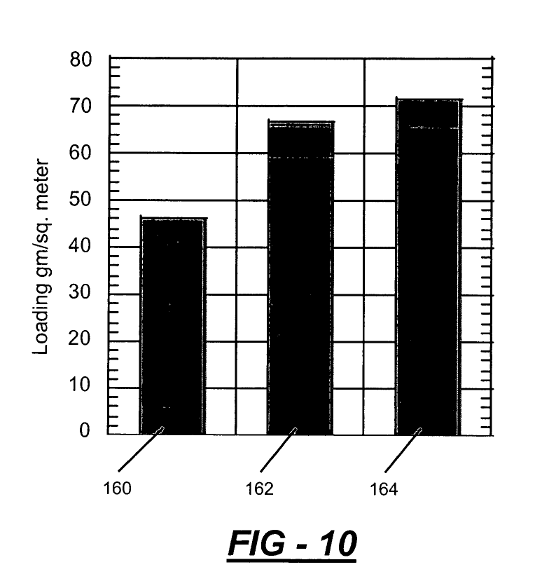

In FIG. 10 the effect of mild heating of the substrate is shown. In all cases the substrate was condenser tubing and the spray parameters were as follows: main gas pressure 300 psi, powder gas pressure 330 psi, main gas temperature 1100° C., powder feed rate 4.00 grams per second, stand off distance 22 millimeters, powder/gas conditioning chamber length 131 millimeters, and traverse speed of 200 centimeters per second. In reference line 160 the tubing was at room temperature when sprayed. In reference line 162 the tubing was heated to 40° C. and then sprayed. In reference line 164 the tubing was heated to 160° C. and then sprayed. The results demonstrate that heating of the substrate prior to spraying increased the loading and therefore deposition efficiency. The continuous in-line manufacturing process of the present invention improves coating quality and the deposition efficiency in part due to high substrate temperature out of the extrusion. Key benefits include: improved cycle time; improved deposition efficiency; improved coating quality; and no need to pre-heat the substrate.

The present invention has been described with respect to its use in high speed manufacturing environments and, more specifically, in the use of the invention to coat condenser tubes. The invention is not, however, so limited. It will find use in virtually all high speed manufacturing environments as will occur to those of ordinary skill in the art.

The foregoing invention has been described in accordance with the relevant legal standards, thus the description is exemplary rather than limiting in nature. Variations and modifications to the disclosed embodiment may become apparent to those skilled in the art and do come within the scope of the invention. Accordingly, the scope of legal protection afforded this invention can only be determined by studying the following claims.

1. A method of kinetic spray coating a substrate comprising the steps of:
a) providing particles of a powder;
b) injecting the particles into a gas/powder exchange chamber and entraining the particles into a flow of a main gas in the gas/powder exchange chamber, the main gas at a temperature insufficient to heat the particles to a temperature above a melting temperature of the particles;
c) directing the particles entrained in the main gas in the gas/powder exchange chamber into a powder/gas conditioning chamber having a length along a longitudinal axis of equal to or greater than 20 millimeters;
d) directing the particles entrained in the flow of gas from the conditioning chamber into a converging diverging supersonic nozzle, said nozzle having a diverging section comprising a first portion and a second portion, said first portion having a cross-sectional area that increases along a length of said first portion and said second portion having a substantially constant cross-sectional area along a length of said second portion; and
e) accelerating the particles to a velocity sufficient to result in adherence of the particles on a substrate positioned opposite the nozzle.

2. The method as recited in claim 1, wherein step c) comprises directing the entrained particles into a powder/gas conditioning chamber having a length of from 20 to 450 millimeters.

3. The method as recited in claim 1, wherein step d) comprises directing the entrained particles into a converging diverging supersonic nozzle having a diverging section with a length of from 350 to 1000 millimeters.

4. The method as recited in claim 1, wherein step d) comprises directing the entrained particles into a converging diverging supersonic nozzle having a diverging section with a first portion having length of from 200 to 400 millimeters.

5. The method as recited in claim 1, wherein step d) comprises directing the entrained particles into a converging diverging supersonic nozzle having a diverging section with a second portion having length of from 150 to 800 millimeters.

6. The method as recited in claim 1, wherein step e) comprises accelerating the particles to a velocity of from 200 to 1300 meters per second.

7. The method as recited in claim 1, wherein step b) comprises entraining the particles in a main gas at a temperature of from 200 to 1000° C.

8. The method as recited in claim 1, wherein step e) further comprises moving one of the nozzle or the substrate at a traverse speed of from 25 to 250 centimeters per second relative to the other of the nozzle or the substrate.

9. The method as recited in claim 1, wherein step a) comprises providing particles having an average nominal diameter of from 1 to 250 microns.

10. The method as recited in claim 1, wherein step d) further comprises providing a substrate comprising at least one of a metal, an alloy, a plastic, a polymer, a ceramic, a wood, a semiconductor or a mixture thereof.

11. The method as recited in claim 1, wherein step a) comprises providing particles comprising at least one of a metal, an alloy, a ceramic, a metal coated ceramic, a polymer, a diamond, a semiconductor, or a mixture thereof.

12. The method as recited in claim 1, wherein step e) further comprises providing a condenser tube as the substrate.

13. The method as recited in claim 12, further comprising at least one of providing the condenser tube directly from a tube extruder and providing the condenser tube in a spool to spool operation.

14. The method as recited in claim 1, further comprising heating the substrate to a temperature of from 40 to 200° prior to step e).

15. The method as recited in claim 1, further comprising heating the particles to a temperature of from 40 to 200° prior to step b).

16. The method as recited in claim 1, wherein step a) further comprises providing a mixture of a first population of powder particles and a second population of powder particles and step e) further comprises accelerating the first population to a velocity sufficient for the first population to adhere to the substrate and the second population to a velocity insufficient for the second population to adhere to the substrate.

17. The method as recited in claim 16, comprising a ceramic as the second population.

18. The method as recited in claim 17, comprising providing an amount of from 1 to 20% by weight of the second population based on the total weight of the first and second populations.

19. A kinetic spray nozzle system comprising:
a gas/powder exchange chamber connected to a first end of a powder/gas conditioning chamber having a length along a longitudinal axis of equal to or greater than 20 millimeters;
a converging diverging supersonic nozzle, said supersonic nozzle having converging section separated from a diverging section by a throat, said diverging section comprising a first portion and a second portion, said first portion having a cross-sectional area that increases along a length of said first portion and said second portion having a substantially constant cross-sectional area along a length of said second portion; and
said converging section connected to a second end of said powder/gas conditioning chamber opposite said first end.

20. A kinetic spray nozzle system as recited in claim 19 wherein said gas/powder exchange chamber has a length of from 40 to 80 millimeters.

21. A kinetic spray nozzle system as recited in claim 19 wherein said powder/gas conditioning chamber has a length of from 20 to 450 millimeters.

22. A kinetic spray nozzle system as recited in claim 19 wherein a largest diameter of said converging section is from 10 to 6 millimeters.

23. A kinetic spray nozzle system as recited in claim 19 wherein said throat has a diameter of from 1 to 6 millimeters.

24. A kinetic spray nozzle system as recited in claim 19 wherein said throat has a diameter of from 2 to 5 millimeters.

25. A kinetic spray nozzle system as recited in claim 19 wherein said diverging section has a length of from 350 to 1000 millimeters.

26. A kinetic spray nozzle system as recited in claim 19 wherein said first portion of said diverging section has a length of from 200 to 400 millimeters.

27. A kinetic spray nozzle system as recited in claim 19 wherein said second portion of said diverging section has a length of from 150 to 800 millimeters.

28. A kinetic spray nozzle system as recited in claim 19 wherein said diverging section has an exit end having a rectangular shape having a long dimension of from 6 to 24 millimeters and a short dimension of from 1 to 6 millimeters.
